(19) United States
(12) Patent Application Publication
(10) Pub. No.: US 2024/0383354 A1
(43) Pub. Date: Nov. 21, 2024

(54) A CABLE HANDLING DEVICE FOR AN ELECTRICAL CHARGER AND AN ELECTRICAL CHARGER FOR A CHARGING VEHICLE

(71) Applicant: DOVER FUELING SOLUTIONS UK LIMITED, Edinburgh (GB)

(72) Inventor: Mattias Martensson, Kävlinge (SE)

(21) Appl. No.: 18/577,579

(22) PCT Filed: Jun. 28, 2022
(86) PCT No.: PCT/EP2022/067735

§ 371 Date: Jan. 8, 2024

(30) Foreign Application Priority Data
Jul. 13, 2021 (SE) 2150935-1

(51) Int. Cl. B60L 53/18; H02G 11/02

(52) U.S. Cl. CPC B60L 53/18; H02G 11/02

(57) ABSTRACT

The invention relates to a cable handling device (1) for an electrical charger (2). The cable handling device (1) comprises a rotatable cable guiding means (3) for handling an electrical cable (4) adapted to charge a vehicle. The cable guiding means (3) allows the cable (4) to be pulled away from and returned back towards the cable handling device (1). The cable (4) is connected to the cable guiding means (3) by means of a swivel connection (5). The invention also relates to an electrical charger (2) for a vehicle.

### TECHNICAL FIELD

The invention relates to a cable handling device for an electrical charger and an electrical charger for charging a vehicle.

### BACKGROUND ART

An electrical charger for a vehicle typically comprises a charging part standing on the ground with a display part arranged directly on the charging part or above the same. A cable used to charge the vehicle is connected to the charging part at one end and to an electronic nozzle at the other end.

When the vehicle is to be charged, the driver parks the vehicle beside the electrical charger and opens the cover or cap of the vehicle. The driver then places the electronic nozzle in the vehicle to begin the charging process.

A difficulty that may arise in connection with charging is that the cable does not reach to the vehicle if parked a distance from the electrical charger. The reason why the vehicle has not been parked sufficiently close to the pump may be difficulty in manoeuvring owing to a limited space round the electrical charger. To allow the cable to reach the vehicle, it is usually necessary for the driver to park his vehicle so that the side of the vehicle where the cap is positioned faces the electrical charger. It is not always known to a driver of an unfamiliar vehicle whether the filler cap is positioned on the left or right side.

This may result in the driver by mistake parking the vehicle on the wrong side of the electrical charger and thus not being able to charge the vehicle without moving it to the other side of the electrical charger since the cable does not reach all the way round the vehicle.

One way of facilitating access to the electrical charger is to provide it with a longer cable. This may, however, cause problems since a longer cable may tend to land on the ground when not used and thus get stuck in or be damaged by passing cars or other vehicles. To prevent this, the electrical charger may be provided with some kind of returning mechanism for the cable.

KR 2018/0128557 discloses a charging cable winding device for an electric vehicle charger, which is capable of rewinding a cable when charging is completed and preventing the withdrawn cable from touching the floor during the charging of an electric vehicle.

A problem common for the returning devices according to prior art as described above is their size, or their extension in or at the electrical charger, which results in bulky and complicated structures.

### SUMMARY OF THE INVENTION

It is an objective of the present invention to mitigate, alleviate or eliminate one or more of the above-identified deficiencies in the art and disadvantages singly or in any combination and solve at least the above-mentioned problems.

According to a first aspect of the invention, these and other objects are achieved, in full or at least in part, by a cable handling device for an electrical charger. The cable handling device comprises a rotatable cable guiding means for handling an electrical cable adapted to charge a vehicle. The cable guiding means allows the cable to be pulled away from and returned back towards the cable handling device. The cable is connected to the cable guiding means by means of a swivel connection.

This is advantageous in that a robust and space-saving device is provided, which enables a smooth and flexible handling of the cable. Further, the problem of the cable getting entangled with the outer environment is eliminated.

A first end of the cable may be connected to the cable guiding means by means of the swivel connection and a second end of the cable may be connected to an electronic nozzle.

The swivel connection may comprise a male part and a female part rotatable in relation to each other about a central axis.

The male part of the swivel connection may have a predetermined number of electrical conducting protrusions and the female part of the swivel connection may have a corresponding number of electrical conducting grooves adapted to receive the electrical conducting protrusions, respectively, allowing the electrical conducting protrusions to travel therein.

The female part of the swivel connection may have a predetermined number of electrical conducting protrusions and the male part of the swivel connection may have a corresponding number of electrical conducting grooves adapted to receive the electrical conducting protrusions, respectively, allowing the electrical conducting protrusions to travel therein.

The electrical conducting grooves may be curved or annular.

Annular grooves enables a 360° rotation of the swivel connection.

The electrical conducting grooves may be provided at predetermined radii with an offset between them, and the electrical conducting protrusions may be provided at the same predetermined radii as the corresponding electrical conducting grooves.

The electrical conducting protrusions may be spring-loaded.

According to a second aspect of the invention, these and other objects, and/or advantages that will be apparent from the following description of embodiments, are achieved, in full or at least in part, by an electrical charger for a vehicle comprising a cable handling device for an electrical charger according to the features described above.

The electrical charger may further comprise a cable storage space in which the cable handling device is arranged.

The cable handling device may be connected to the electrical charger by means of a swivel connection.

Effects and features of the second aspect of the present invention are largely analogous to those described above in connection with the first aspect of the inventive concept. Embodiments mentioned in relation to the first aspect of the present invention are largely compatible with the further aspects of the invention.

Other objectives, features and advantages of the present invention will appear from the following detailed disclosure, from the attached claims, as well as from the drawings. It is noted that the invention relates to all possible combinations of features.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise.

As used herein, the term “comprising”, and variations of that term are not intended to exclude other additives, components, integers or steps.

### BRIEF DESCRIPTION OF THE DRAWINGS

The above, as well as additional objects, features and advantages of the present invention, will be better understood through the following illustrative and non-limiting detailed description of embodiments of the present invention, with reference to the appended drawings, where the same reference numerals may be used for similar elements, and wherein:

FIGS. 1A and 1B is perspective views of exemplary embodiments of a cable handling device for an electrical charger according to a first aspect of the invention.

FIG. 2 is a perspective view of one exemplary embodiment of an electrical charger for a vehicle according to a second aspect of the invention.

FIG. 3 to 4 and 6 to 7 are perspective views of exemplary embodiments of electrical conducting grooves and protrusions in a swivel connection of the cable handling device.

FIG. 5 is a perspective view of one exemplary embodiment of electrical conducting flat plates and protrusions in a swivel connection of the cable handling device

### DETAILED DESCRIPTION OF PREFERRED EMBODIMENTS OF THE INVENTION

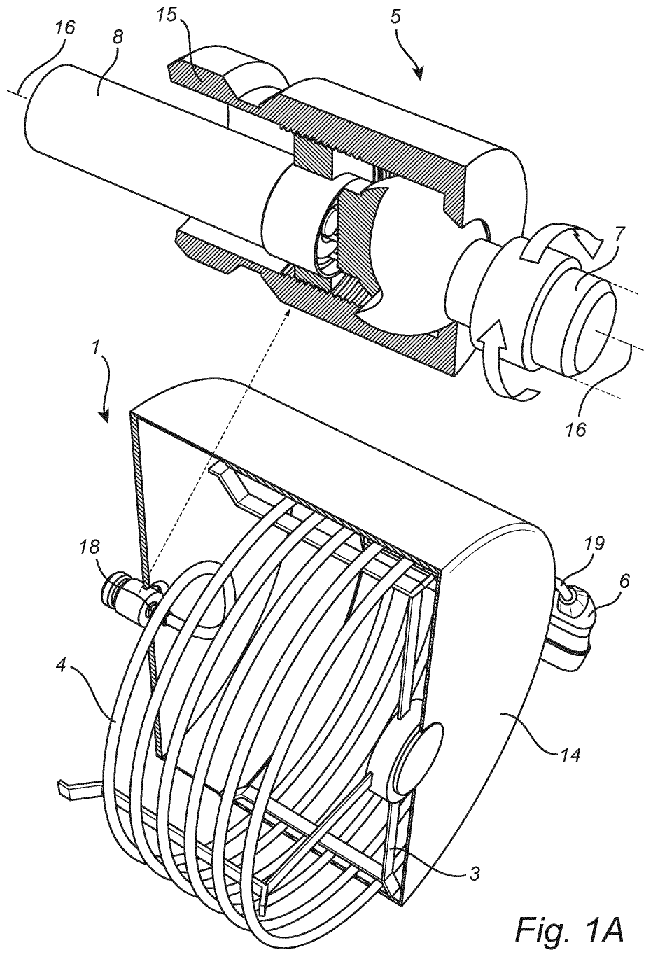

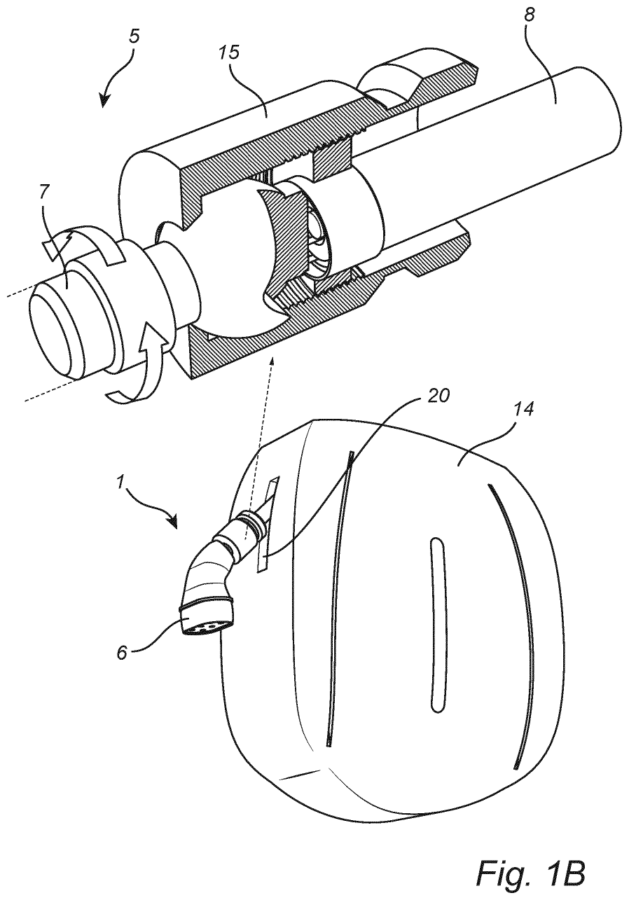

FIG. 1A illustrates an exemplary embodiment of a cable handling device 1 for an electrical charger 2. A rotatable cable guiding means 3 for handling an electrical cable 4 adapted to charge a vehicle is arranged in or at the cable handling device 1. The cable guiding means 1 makes it possible for the cable 4 to be pulled away from and returned back towards the cable handling device 1. The cable guiding means 3 is for example constituted by a roller which is connected to an elastic element or a motor adapted to allow the cable 4 to be pulled away from cable handling device 1 and which will pull the cable back towards the cable handling device 1 via the cable guiding means 3 when the charging of the vehicle is completed. The elastic element may be a spring.

When the cable 4 is pulled back towards the cable handling device 1, the cable guiding means 3 may wind up the cable by rotating around a central axis of the cable guiding means 3. The cable guiding means 3 may thus function as a cable winder. When the cable 4 is pulled away from the cable handling device 1, the cable guiding means 3 may wind out the cable by rotating around the axis of the cable guiding means 3 in an opposite direction from when the cable 4 is pulled back. The cable guiding means 3 may prevent the cable 4 from tangling during extraction and retraction of the cable 4. The cable guiding means 3 may comprise a housing 14. The housing 14 may encapsule the cable 4 when retracted to protect it from tear.

In this specific embodiment, the first end 18 of the cable is connected to the cable guiding means 3 by means of the swivel connection 5 and a second end 19 of the cable 4 is connected to an electronic nozzle 6. This way, the cable 4 will be able to be returned onto the cable guiding means 4 by means of rotation of the same without breaking. The swivel connection 5 allows the cable guiding means 3 to rotate without twisting the cable 4 where it connects to the cable guiding means 3. In other words, the swivel connection 5 is able to maintain an electrical current through the swivel connection 5 while also being able to rotate around a central axis 16 of the swivel connection 5.

The swivel connection 5 may be connected to the housing 14 of the cable guiding means 3. More specifically, an outer part 15 of the swivel connection 5 may be fixedly connected to the housing 14. The rotatable part of the cable guiding means 3 may be rotatable connected to the housing 14. An opening may be provided at a lateral side of the housing 14 for allowing the cable to run through. However, the opening may be provided on any side of the housing.

In the exemplary embodiment of FIG. 1A, the central axis 16 of the swivel connection 5 is coincident with the central axis of the cable guiding means 3. An effect of this is that the rotation of the cable guiding means 3 when pulling the cable 4 out from or back towards the cable handling device 1 can be counteracted by the rotation in the swivel connection 5. This allows the first end of the cable to be protected from twisting.

The swivel connection 5, as illustrated in an exploded view herein, comprises a male part 7 and a female part 8. As illustrated herein, the female part 8 may be fixedly connected to the outer part 15 of the swivel connection 5. For example, the female part 8 may be screwed into place by threads. The male part 7 may be rotatably arranged in the outer part 15 such that it is held in place but still able to rotate around the central axis 16 of the swivel connection 5. However, it should be noted that the swivel connection 5 may be inverted. In other words, the male part 7 may be fixed to the outer part 15 while the female part 8 is rotatably arranged in the outer part 15.

FIG. 1B illustrates another exemplary embodiment of the cable handling device 1 for an electrical charger 2. In this example, the cable handling device 1 is provided within another housing 14. The second end 19 of the cable 4 and the electronic nozzle 6 may be connected by a swivel connection 5. This allows for an improved handling of the electronic nozzle 6 and reduces wear and tear of the second end 19 of the cable 4 which otherwise can be caused by twisting of the cable 4. Having the swivel connection 5 between the electronic nozzle 6 and the second end of the cable 4 makes it easier to manoeuvre when it is to be attached to the vehicle.

Further illustrated in FIG. 1B is the opening 20 for allowing the cable 4 to be pulled out. The cable 4 may be pulled out in a tangentially direction from the cable guiding means 3 through the opening 20.

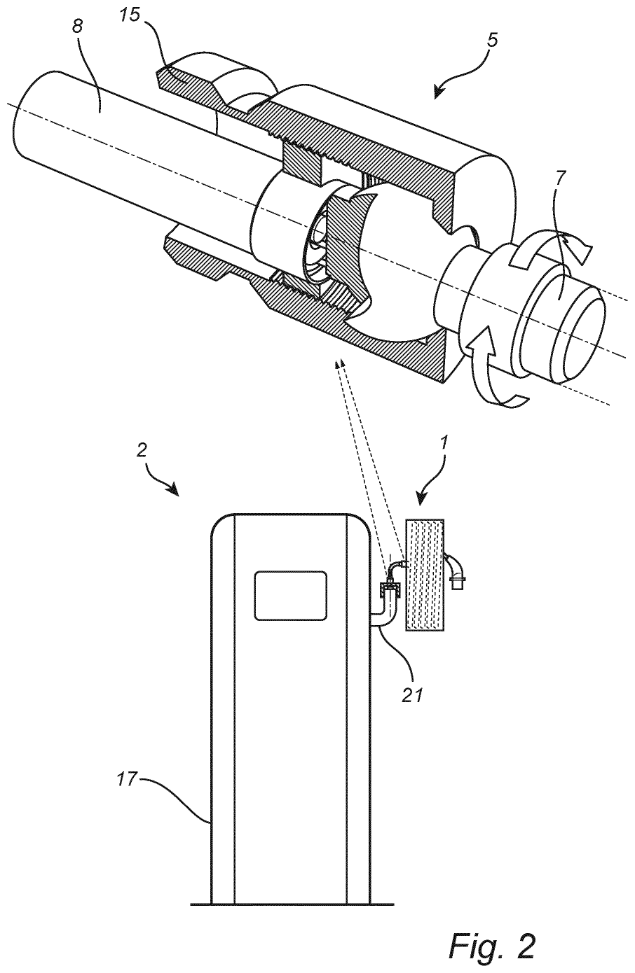

FIG. 2 illustrates an exemplary embodiment of the electrical charger 2 for charging a vehicle. The electrical charger 2 comprises a charging body 17. The charging body 17 may comprise parts which are normally found on an electrical charger for vehicles, e.g. a display for controlling the charger, means for receiving electricity from an electrical grid and so forth. The electrical charger 2 further comprises the cable handling device 1 as discussed in connection with FIGS. 1A and 1B. The cable handling device 1 may be provided on an outside of the electrical charger 2 as illustrated herein. Alternatively, the cable handling device 1 may be provided within the electrical charger 2. The electrical charger 2 may comprise a cable storage space in which the cable handling device 1 can be arranged.

The cable handling device 1 may be provided at a side of the charging body 17 as illustrated herein. The cable handling device 1 may be connected to the charging body 17 by a swivel connection 5 like the swivel connection 5 provided within the cable handling device 1. The swivel connection 5 connecting the charging body 17 and the cable handling device 1 may be arranged so that the central axis 16 of the swivel connection 5 is vertical. The outer part 15 of the female part 8 of the swivel connection 5 is connected to the charging body 17 via a gooseneck pipe 21. The gooseneck pipe 21 comprises an horizontal part connected to the charging body 17 and a vertical part connected to the outer part 15 of the swivel connection 5.

Thus, the cable handling device 1 can rotate around the central axis of the swivel connection 5. This provides a more agile and flexible electrical charger 2.

The gooseneck pipe 21 enables to space out the cable handling device 1 from the charging body 17 and provides more freedom for the rotation of the cable handling device 1.

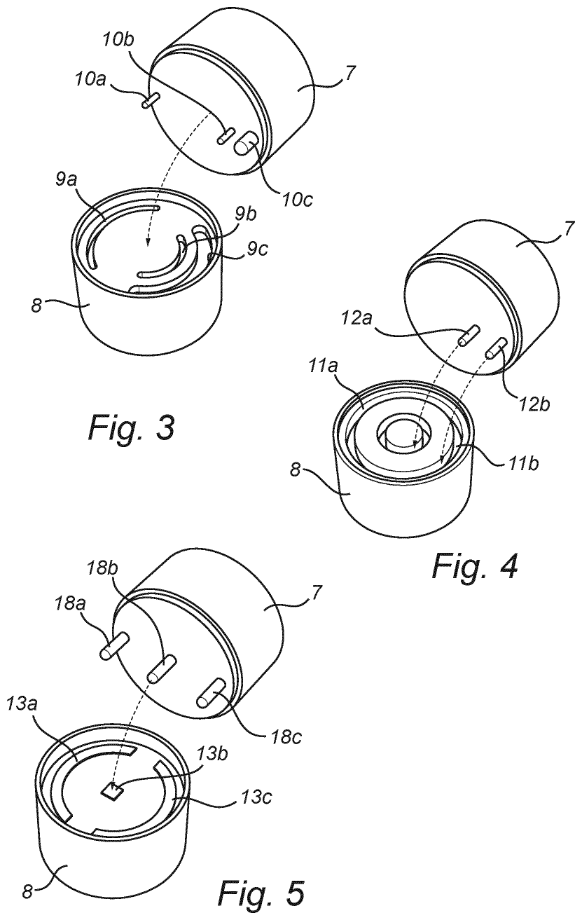

FIG. 3 to 4 and 6 to 7 illustrate exemplary embodiments of electrical conducting grooves 9a-c, 11a-b, 19, 21a-c in the female part 8 of the swivel connection 5 in the cable handling device 1. As stated above, further connections in the electrical charger 2 can be swivel connections 5, such as, for example, the connection between the cable handling device 1 and the electrical charger 2. Also, these further swivel connections 5 can be provided with electrical conducting protrusions 10a-c, 12a-b, 18a-c, 20, 22a-c or pins which travels within or engages with electrical conducting grooves 9a-c, 11a-b, 19, 21a-c or tracks.

The electrical conducting grooves 9a-c, 11a-b, 19, 21a-c are each delimited by a border 22 having a conductive surface contacting with the electrical conducting protrusions 10a-c, 12a-b, 18a-c, 20, 22a-c.

The borders delimiting the electrical conducting grooves 9a-c, 11a-b, 19, 21a-c are each connected to an electrical wire linked to a power source.

The electrical conducting protrusions 10a-c, 12a-b, 18a-c, 20, 22a-c are each connected to an electrical of the electric cable 4.

The male part 7 and the female part 8 of the swivel connection 5 can be rotatable connected to each other about the central axis 16 of the swivel connection 5.

In FIG. 3 to 4 and 6 to 7, the female part 8 comprises the electrical conducting grooves 9a-c, 11a-b, 19, 21a-c and the male part comprises the electrical conducting protrusions 10a-c, 12a-b, 18a-c, 20, 22a-c. However, it should be noted that the opposite may be possible as well. In other words, the female part may comprise the electrical conducting protrusions 10a-c, 12a-b, 18a-c, 20, 22a-c while the male part comprises the electrical conducting grooves 9a-c, 11a-b, 19, 21a-c.

The electrical conducting protrusions 10a-c, 12a-b, 18a-c, 20, 22a-c may be spring-loaded. Having the electrical conducting protrusions 10a-c, 12a-b, 18a-c, 20, 22a-c spring-loaded ensures the connection to the electrical conducting grooves 9a-c, 11a-b, 19, 21a-c.

It should be noted that the size, shape of the electrical conducting grooves 9a-c, 11a-b, 19, 21a-c and protrusions 10a-c, 12a-b, 18a-c, 20, 22a-c as well as size ratio between the electrical conducting grooves 9a-c, 11a-b, 19, 21a-c and protrusions 10a-c, 12a-b, 18a-c, 20, 22a-c are to be regarded as non-limiting and for illustrative purpose only.

In FIG. 3, the female part 8 of the swivel connection 5 comprises three electrical conducting grooves 9a-c. The male part 7 of the swivel connection 5 comprises tree electrical conducting protrusions 10a-c, each corresponding to a respective electrical conducting groove 9a-c of the female part 8.

The three pairs of electrical conducting grooves 9a-c and protrusions 10a-c may correspond to plus, minus and ground respectively, of the electrical connection.

The electrical conducting protrusions 10a-c may be of different sizes as illustrated herein. Alternatively, they may be of the same size.

The electrical conducting grooves 9a-c are curved or annular in order to follow a trajectory of the electrical conducting protrusions 10a-c when rotated.

The electrical conducting grooves 9a-c are provided at predetermined radii. The predetermined radii of the electrical conducting grooves 9a-c may have an offset between them, in order to not interfere with each other. In other words, the electrical conducting grooves 9a-c may extend besides each other without overlapping. Overlapping may be in the sense of having the electrical connection leak between different electrical conducting grooves 9a-c.

The electrical conducting grooves 9a-c are separated by a non-conductive material. The protrusions 10a-c, 12a-b, 18a-c, 20, 22a-c are also separated by a non-conductive material.

The female part 8 comprises a first electrical conducting grooves 9a, a second electrical conducting grooves 9b and a third electrical conducting grooves 9c having all a curved shape. The first electrical conducting grooves 9a and the third electrical conducting grooves 9c have the same radii but are separated for avoiding electric contact. The first electrical conducting grooves 9a and the third electrical conducting grooves 9c have a different width. Alternatively, that could have same width. The first electrical conducting grooves 9a and the third electrical conducting grooves 9c have quite the same length.

The second electrical conducting grooves 9b has a smaller radii than the first and third electrical conducting grooves 9a, 9c. The second electrical conducting grooves 9b is located in front of the third electrical conducting grooves 9c and has a smaller length.

The corresponding electrical conducting protrusions 10a-c are provided at the same radii as the respective electrical conducting groove 9a-c.

In the exemplary embodiment of FIG. 4, the electrical conducting grooves 11a-b forms complete circles which allows for a 360 degrees rotation of the swivel connection 5. The embodiment of FIG. 4 further illustrates the swivel connection 5 having two electrical conducting grooves 11a-b and corresponding protrusions 12a-b. The electrical conducting protrusions may be provided on a common half of the male part 7 as illustrates herein. Alternatively, they may be provided at different halfs as illustrates in FIG. 3.

In the exemplary embodiment of FIG. 5, three electrical conducting protrusions 18a-c are provided. The three electrical conducting protrusions 18a-c are of the same size and equally distributed in a row. The electrical conducting grooves are replaced with electrical conducting flat plates 13a-c to which the electrical conducting protrusions 18a-c can engage. The embodiment of FIG. 5 further illustrates an electrical conducting protrusion 18b provided at a central axis 16 of the male part 7 of the swivel connection 5.

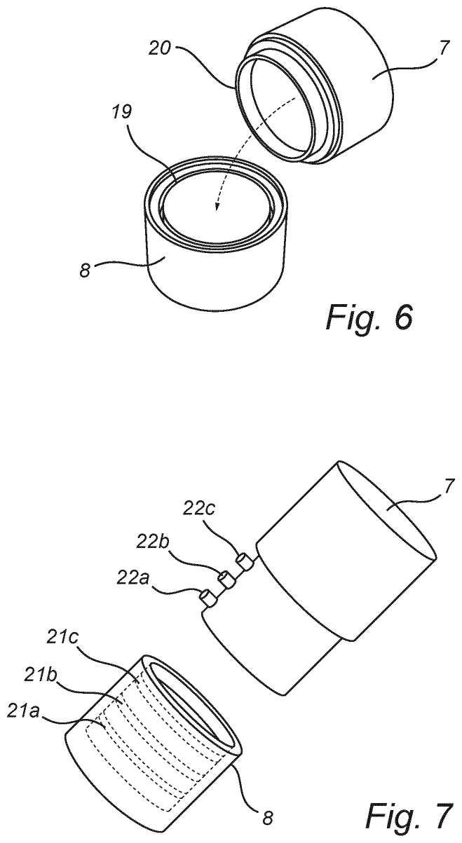

In the exemplary embodiment of FIG. 6, a single electrical conducting protrusion 20 is provided on the male part 7 of the swivel connection 5. The single electrical conducting protrusion 20 has a continuous cylindrical shape. The female part 8 of the swivel connection 5 has a corresponding electrical conducting groove 19.

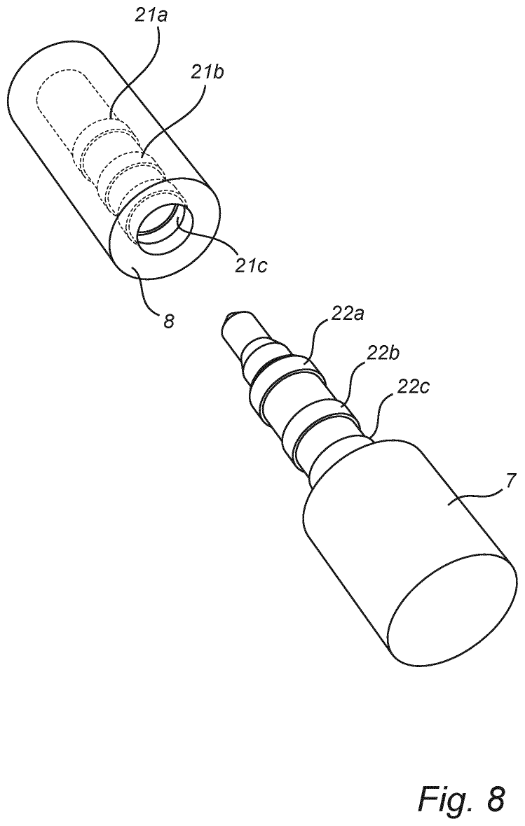

In the exemplary embodiment of FIG. 7, the electrical conducting protrusions 22a-c are provided on a side of the male part 7. Correspondingly, the electrical conducting grooves 21a-c are provided along an inner side of the female part 7. The electrical conducting protrusions 22a-c are arranged to decrease in diameter from the top to the bottom of the male part 7, much like a AUX-connection.

In the exemplary embodiment of FIG. 8, the electrical conducting protrusions 22a-c are provided on a side of the male part 7. Correspondingly, the electrical conducting grooves 21a-c are provided along an inner side of the female part 7. The

It is understood that other variations in the present invention are contemplated and, in some instances, some features of the invention can be employed without a corresponding use of other features. Accordingly, it is appropriate that the appended claims be construed broadly in a manner consistent with the scope of the invention.

For instance, one or more features of an exemplary embodiment in any of FIG. 3 to 7 can be combined with one or more features of another exemplary embodiment in any of FIG. 3 to 7.

1. A cable handling device for an electrical charger, comprising
a rotatable cable guiding means for handling an electrical cable adapted to charge a vehicle, the cable guiding means allowing the cable to be pulled away from and returned back towards the cable handling device,
wherein the cable guiding means comprises a housing, and
wherein a first end of the cable is connected to the housing of the cable guiding means by means of a swivel connection, and a second end of the cable is connected to an electronic nozzle.

2. The cable handling device according to claim 1, wherein the swivel connection comprises a male part and a female part rotatable in relation to each other about a central axis.

3. The cable handling device according to claim 2, wherein the male part of the swivel connection comprises a predetermined number of electrical conducting protrusions and the female part of the swivel connection comprises a corresponding number of electrical conducting grooves adapted to receive the electrical conducting protrusions, respectively, allowing an electrical connection between each electrical conducting protrusion and each electrical conducting groove.

4. The cable handling device according to claim 2, wherein the female part of the swivel connection comprises a predetermined number of electrical conducting protrusions and the male part of the swivel connection comprises a corresponding number of electrical conducting grooves adapted to receive the electrical conducting protrusions, respectively, allowing the electrical conducting protrusions to travel therein.

5. The cable handling device according to claim 3, wherein the electrical conducting grooves are curved or annular.

6. The cable handling device according to claim 5, wherein the electrical conducting grooves are provided at predetermined radii with an offset between them, and
wherein the electrical conducting protrusions are provided at the same predetermined radii as the corresponding electrical conducting grooves.

7. The cable handling device according to claim 3, wherein the electrical conducting protrusions are spring-loaded.

8. An electrical charger for a vehicle, comprising a cable handling device according to any one of the preceding claims.

9. The electrical charger according to claim 8, further comprising a cable storage space in which the cable handling device is arranged.

10. The electrical charger according to claim 8, wherein the cable handling device is connected to the electrical charger by means of a swivel connection.
